(19) United States
(12) Patent Application Publication
(10) Pub. No.: US 2013/0013277 A1
(43) Pub. Date: Jan. 10, 2013

(54) Ghost Region Approaches for Solving Fluid Property Re-Distribution

(76) Inventor: Jiun-Der Yu, Sunnyvale, CA (US)

(21) Appl. No.: 13/178,752

(22) Filed: Jul. 8, 2011

(51) Int. Cl. G06G 7/50

(52) U.S. Cl. 703/9

(57) ABSTRACT

Systems and methods for simulating multi-phase incompressible immiscible fluid flows with non-uniform fluid properties in each of the phases are presented. In embodiments, finite-difference-based simulations enable more precise modeling of a two-phase system, such as by way of example and not limitation, an ink and air system. In embodiments, values of a property of one fluid in the fluid system exist in the region occupied by that fluid and not in the region occupied by the other fluid. To facilitate simulating the multi-phase fluid system, a set of artificial values of the property of the first fluid are assigned in the region of the second fluid thereby creating a “ghost region” of values.

### CROSS-REFERENCE TO RELATED APPLICATIONS

This application is related to U.S. Pat. No. 7,085,695, entitled “A Slipping Contact Line Model and the Mass-Conservative Level Set Implementation for Ink-Jet Simulation,” issued on Sep. 25, 2003, and listing Jiun-Der Yu and Shinri Sakai as inventors. The disclosure of this patent is incorporated herein by reference in its entirety.

This application is related to U.S. Pat. No. 7,117,138, entitled “Coupled quadrilateral grid level set scheme for piezoelectric ink jet simulation,” issued on Oct. 3, 2006, and listing Jiun-Der Yu and Shinri Sakai as inventors. The disclosure of this patent is incorporated herein by reference in its entirety.

This application is related to U.S. Pat. No. 7,478,023, entitled “A coupled algorithm for viscoelastic ink jet simulations,” issued on Jan. 13, 2009, and listing Jiun-Der Yu as inventor. The disclosure of this patent is incorporated herein by reference in its entirety.

This application is related to U.S. Pat. No. 7,921,001, entitled “Coupled algorithms on quadrilateral grids for generalized axi-symmetric viscoelastic fluid flows,” issued on Apr. 5, 2011 and listing Jiun-Der Yu as inventor. The disclosure of this patent is incorporated herein by reference in its entirety.

### BACKGROUND

1. Field of Invention

The present application is directed towards systems and methods for simulating incompressible fluid flows with non-uniform fluid properties.

2. Description of the Related Art

Results of computational fluid dynamics (CFD) simulation can be very useful in designing systems. For example, CFD ink jet simulations are extremely beneficial in designing piezoelectric (PZT) ink-jet print heads. An analytical tool, such as an equivalent circuit, receives as an input the dynamic voltage to be applied to the piezoelectric PZT actuator and simulates the ink behavior under the influence of the ink cartridge, supply channel, vibration plate, and PZT actuator. That is, from the input voltage and an ink flow rate, the equivalent circuit calculates an inflow pressure that drives the CFD code. The CFD code then solves the governing partial differential equations, i.e., the incompressible Navier-Stokes equations for fluid velocity, pressure, and interface position, and feeds back the ink flow rate to the equivalent circuit. The sequence may be repeated as long as needed.

Although prior computational fluid dynamics (CFD) simulations have been useful, these CFD simulations have limitations. Often, in solving the CFD, simplifications or assumptions are made to help reach a solution. However, these simplifications can make the simulation less realistic. Accordingly, there generally is a continual desire to improve simulations—to make them be more accurate, more efficient, or both.

Accordingly, what is needed are systems and methods for improving the simulation of complex multi-phase fluid flow systems.

### SUMMARY

The present invention comprises systems and methods for simulating multi-phase incompressible immiscible fluid flows with non-uniform fluid properties in each of the phases. Embodiments of the present invention track the concentration distributions by solving concentration convection/diffusion equations. For illustration purposes and not by way of limitation, a two-phase (ink and air) system is used; it shall be noted that other fluid configuration may also be used. It is shown herein how to update the solute (dye or pigment) concentration distribution by solving a concentration convection equation. The ink density and dynamic viscosity are functions of the concentration distribution. In depicted embodiments, the solute concentration only exists in the region occupied by ink. In embodiments, the air density and dynamic viscosity are assumed to be uniform and constant in its region. Embodiments of the present invention also work well if another concentration distribution needs to be tracked in the second fluid (air). Embodiments of the present invention also work well if there are more than two phases and/or there are concentrations to track in each of the phases.

Embodiments of the present invention include methods that have been encoded upon one or more non-transitory computer-readable media with instructions for one or more processors or processing units to perform. The methods may include a plurality of instructions that are executed by the processor.

In embodiments, a method for simulating fluid flow in a solution domain comprising a first fluid in a first subdomain, a second fluid in a second subdomain, and an interface between the first fluid and the second fluid comprises: determining values in the first subdomain of a property of the first fluid, the property being unique to the first fluid; assigning ghost values of the property in the second subdomain, wherein the first subdomain and the second subdomain form the solution domain; and using at least some of the values in the first and the second subdomains for finite difference analysis of the property of the first fluid. In embodiments, the step of assigning ghost values for the property in the second subdomain comprises using at least some of the values of the property of the first fluid in the first subdomain to generate ghost values of the property in the second subdomain. In embodiments, the first fluid is ink, the second fluid is air, and the property is solute concentration.

In embodiments, the step of using at least some of the values of the property of the first fluid in the first subdomain to generate ghost values of the property in the second subdomain comprises identifying points on the interface and values of the property for the identified points on the interface. In embodiments, these values for the identified points are used to generate ghost values of the property in the second subdomain. In embodiments, the values for the identified points may be obtained using interpolation or extrapolation.

In embodiments, the step of using at least some of the values in the first and the second subdomains for finite difference analysis of the property of the first fluid comprises: performing finite difference analysis, with reference to both a quadrilateral grid in a physical space and a uniform square grid in a computational space, equations governing two-phase fluid flow including a level set convection equation having a level set function for the flow of the first and second fluids through at least the portion of a channel, the level set function taking into consideration an effect of the interface as it moves through at least the portion of the channel, wherein the equations are first derived for the quadrilateral grid in the physical space and then transformed to the computational space for application on the uniform square grid on which the equations are solved; and simulating the flow of the first fluid through at least the portion of the channel based on the performed finite difference analysis.

In embodiments, a method for simulating fluid flow in a domain segmented into a plurality of cells and the domain comprising a first region occupied by a first fluid, a second region occupied by a second fluid, and an interface between the first and second fluids, comprising the steps of: obtaining level set values of the interface for each cell from the plurality of cells of the domain; obtaining values of a property of the first fluid in the first region occupied by the first fluid, the property being unique to the first fluid; generating artificial values of the property in the second region occupied by the second fluid; and updating the level set values and the values of the first fluid in the first region during an iteration.

In embodiments, the method may further comprise: (a) deriving partial differential equations applicable to a quadrilateral grid in a physical space, including deriving a viscosity term, a surface tension term, and a level set convection equation for two-phase flows; (b) calculating a transformation for transforming the derived partial differential equations for application to a uniform square grid in a computational space; and (c) solving the derived and transformed partial differential equations to determine the flow of the first fluid through, and ejection from, the channel. In embodiments, in step (c) the derivatives of velocity, pressure, and level set for the flow of the first fluid in the derived and transformed partial differential equations are calculated with reference to the uniform square grid in the computational space.

In embodiments, a method for simulating fluid flow comprises: [a] defining a domain comprising a first fluid occupying a first region, a second fluid occupying a second region, and an interface between the first fluid and the second fluid, the domain being divided into a plurality of cells; [b] initializing a level set value for each of the plurality of cells in the domain and initializing a value of a property unique to the first fluid for each of the plurality of cells in the domain, the values of the property assigned to cells from the plurality of cells in the second region being artificial values; and [c] responsive to incrementing a time value, updating the level set value for each of the plurality of cells in the domain and the value of the property unique to the first fluid for each of the plurality of cells in the domain; [d] updating density and velocity values in each cell in the domain; [e] solving a set of Navier-Stokes equations; and [f] enforcing incompressibility of at least one of the first and second fluids. In embodiments, the method is iterated by returning to step [c] until a stop condition is met.

In embodiments, the method further comprises, responsive to one or more of the level set values meeting a condition to be re-initialized, re-initializing a level set value for each of the plurality of cells in the domain and re-initializing a value of the property unique to the first fluid for each of the plurality of cells in the region of the second fluid, the values of the property assigned to cells from the plurality of cells in the second region being artificial values. In embodiments, the step of re-initializing a value of the property unique to the first fluid for each of the plurality of cells in the second domain is based on at least some of the values of the property of the first fluid in the first region.

In embodiments of the present invention, a system or a fluid or fluids may be prepared in response to the results of a simulation.

Some features and advantages of the invention have been generally described in this summary section; however, additional features, advantages, and embodiments are presented herein or will be apparent to one of ordinary skill in the art in view of the drawings, specification, and claims hereof. Accordingly, it should be understood that the scope of the invention shall not be limited by the particular embodiments disclosed in this summary section.

### BRIEF DESCRIPTION OF THE DRAWINGS

Reference will be made to embodiments of the invention, examples of which may be illustrated in the accompanying figures, in which like parts may be referred to by like or similar numerals. These figures are intended to be illustrative, not limiting. Although the invention is generally described in the context of these embodiments, it should be understood that it is not intended to limit the scope of the invention to these particular embodiments.

FIG. 1 depicts a typical structure of an ink-jet nozzle or channel.

FIG. 2 illustrates the transformation of grid points in a computational space to a physical space according to embodiments of the present invention.

FIG. 3 depicts a body-fitted quadrilateral grid in the physical space according to embodiments of the present invention.

FIG. 4 depicts the corresponding uniform square grid system of FIG. 3 in the computational space according to embodiments of the present invention.

FIG. 5 is a graphical illustration of a typical ink-jet driving voltage with respect to time over one cycle according to embodiments of the present invention.

FIG. 6 is a graphical illustration of a typical ink-jet inflow pressure with respect to time over one cycle according to embodiments of the present invention.

FIG. 7 is a schematic diagram of the location of material property components according to embodiments of the present invention.

FIG. 8 depicts an algorithm which would trace the zero level of the level set according to embodiments of the present invention.

FIG. 9 graphically depicts methods for generating a value for a ghost region point according to embodiments of the present invention.

FIG. 10 is a flow chart illustrating a numerical algorithm according to embodiments of the invention.

FIG. 11 is a sequence of images illustrating the ejection of an ink droplet from an ink-jet printer.

FIG. 12 is a block diagram illustrating an exemplary system which may be used to implement aspects of the present invention.

### DESCRIPTION OF THE PREFERRED EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, including software, hardware, or firmware, or combinations thereof. Accordingly, the figures described herein are illustrative of specific embodiments of the invention and are meant to avoid obscuring the invention.

Components, or modules, shown in block diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components or modules.

Furthermore, connections between components within the figures are not intended to be limited to direct connections. Rather, data between these components may be modified, re-formatted, or otherwise changed by intermediary components. Also, additional or fewer connections may be used. It shall also be noted that the terms “coupled” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. The appearances of the phrases “in one embodiment,” “in an embodiment,” or “in embodiments” in various places in the specification are not necessarily all referring to the same embodiment or embodiments.

### 1. Introduction

### 1.1 Introduction—Background

The present invention relates to systems and methods for simulating multi-phase incompressible immiscible fluid flows with non-uniform fluid properties. In embodiments of the present invention, the flows may be produced using inkjet technology. It shall be noted that the present invention may be used to simulate fluid flows produced using other techniques without going beyond the spirit and scope of the present invention.

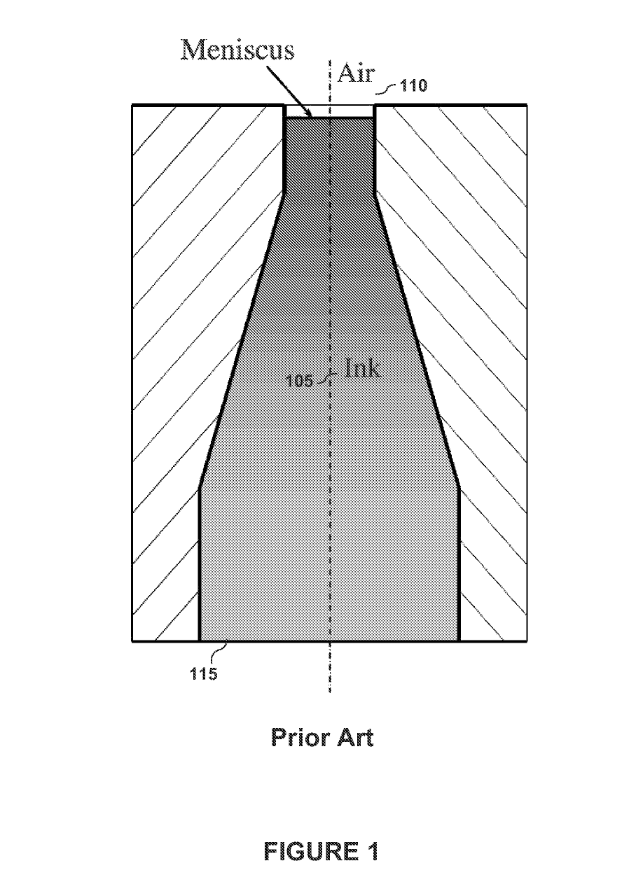

In embodiments in U.S. Pat. No. 7,117,138, entitled “Coupled quadrilateral grid level set scheme for piezoelectric ink jet simulation,” issued on Oct. 3, 2006 and listing Jiun-Der Yu and Shinri Sakai as inventors, an ink droplet ejection simulation technology was developed. The physical model was a two-phase (ink and air) incompressible immiscible Newtonian fluid flow system with surface tension and density/viscosity jump across the interface separating the two phases. In the patent document, the ink (air) density and dynamic viscosity were assumed to be constant in time and uniform in the region occupied by ink (air). The geometry considered was axisymmetric. FIG. 1 shows a typical structure of an ink jet nozzle (not to scale). Ink is stored in a cartridge, and driven through the nozzle in response to a dynamic pressure at the lower boundary. For boundary conditions on solid walls, it was assumed that both the normal and tangential components of the fluid velocity vanish; this is amended through a (Hoffman-type) macroscopic slipping contact line model which describes the air-fluid-wall interactions. The numerical method was based on a higher-order quadrilateral grid finite difference level set projection technology: the quadrilateral grid finite difference method was designed to faithfully discretize the nozzle geometry; the level set method was employed to track the ink-air interface and calculate the surface tension force; the higher-order Godunov method was implemented for the nonlinear convection terms; and the projection method was used to enforce the fluid incompressibility. For practical ink jet simulations, the ink droplet ejection code was connected to an equivalent circuit, which simulates the internal ink flow considering the effects of the ink cartridge, ink supply channel, pressure chamber, and piezoelectric actuator. Simulation results are pretty close to those observed in experiments.

In embodiments in U.S. Pat. No. 7,478,023, entitled “A coupled algorithm for viscoelastic ink jet simulations,” issued on Jan. 13, 2009 and listing Jiun-Der Yu as inventor, the simulation technology in U.S. Pat. No. 7,117,138 was extended for viscoelastic (e.g., polymer ink) ink jet simulations. The ink was assumed to behave according to the Oldroyd-B model in embodiments in U.S. Pat. No. 7,478,023. However, the simulation technology in U.S. Pat. No. 7,478,023 is not limited to it. In embodiments in U.S. Pat. No. 7,921,001, entitled “Coupled algorithms on quadrilateral grids for generalized axi-symmetric viscoelastic fluid flows,” issued on Apr. 5, 2011 and listing Jiun-Der Yu as inventor (the disclosure of which is incorporated herein in its entirety), the quadrilateral grid level set scheme was further extended to the so call generalized axi-symmetric two-phase viscoelastic fluid flow simulations with radial, axial, and azimuthal velocity components.

In embodiments in these patent documents, it was assumed the material properties (like ink density and dynamic viscosity) were uniform in the region occupied by each phase. That is to say, the densities (viscosity) of ink and air are different. But the ink density (viscosity) is uniform and constant in the region occupied by ink while the air density (viscosity) is uniform and constant in the region occupied by air

### 1.2 Problem Description

In real world, the ink density, dynamic viscosity, or other material properties may not be uniform. As an example, the concentration of surfactant, which is added to adjust the surface tension, may not be uniform and its concentration distribution may change during the ejection of ink. As another example, when the print head does not print for a period of time, the solvent (typically water) evaporates from the nozzle opening. The solute (dye or pigment) concentration at the nozzle opening gradually increases and, hence, the ink density and dynamic viscosity at the nozzle opening rise accordingly. The diffusion effect usually propagates the high solute concentration toward the bottom of the nozzle, the connection channel, and even the pressure chamber. FIG. 1 depicts a typical ink jet nozzle for fluid dynamics simulation according to embodiments of the invention. In FIG. 1, the gray shading of the ink 105 shows that the ink viscosity can be higher at the nozzle opening 110 and lower at nozzle inflow 115.

Aspects of the current patent document are to simulate multi-phase incompressible immiscible fluid flows with non-uniform fluid properties in each of the phases. Embodiments of the present invention track the concentration distributions by solving certain concentration convection/diffusion equations. For simplicity, but not by way of limitation, a two-phase (ink and air) system is used for illustration purposes. Embodiments show how to update the solute (dye or pigment) concentration distribution by solving a concentration convection equation. In embodiments, the ink density and dynamic viscosity are functions of the concentration distribution. It should be noted that the solute concentration exists in the region occupied by ink since it contains the solute and not the air. In embodiments, the air density and dynamic viscosity are assumed to be uniform and constant in its region. It should be noted that embodiments of the present invention will work well if another concentration distribution needs to be tracked in the second fluid (air). It should also be noted that the embodiments of the present invention will work well if there are more than two phases and/or there are concentrations to track in each of the phases.

### 1.3 Overview of the Sections

In this patent document, the governing equations and boundary conditions with non-uniform fluid properties, including those used on quadrilateral grids, are given in section 2. Embodiments of the detailed numerical algorithm are presented in section 3. Since, in embodiments, we have to update the concentration distribution in simulation, the detailed ghost region method and the concentration re-initialization algorithm are explained in section 5, with the closely-related level set re-initialization algorithm presented in section 4.

### 2. Governing Equations

### 2.1 Level Set Formulation

In embodiments, both of the fluids are governed by the incompressible Navier-Stokes equations (1), which is set forth in the Appendix along with the other numbered equations referenced in this patent document. In equations (1), the rate of deformation tensor and the fluid velocity are respectively defined in equations (2), where

$$\frac{D}{Dt} = \frac{\partial }{\partial t} + ( u \cdot ∇ )$$

is the Lagrangian time derivative, p the pressure, ρ the density, and μ the dynamic viscosity. The subscript i=1, 2 is used to denote the variable or coefficient in fluid #1 (e.g., ink) or fluid #2 (e.g., air). The density ρ₁ and dynamics viscosity μ₁ are functions of solute (dye or pigment) concentration C of fluid #1 (ink).

In embodiments, the boundary conditions at the interface of the two phases are the continuity of the velocity and the jump condition—see equation (3), where n is the unit normal to the interface drawn from fluid #2 to fluid #1 and κ is the curvature of the interface. In embodiments, because the size of typical ink jet print heads is small, the gravity term is not important and is omitted. It shall be noted that the inclusion of a gravity term does not change any part of the numerical scheme described herein.

In embodiments, the level set method is used to trace the interface or boundary between the fluids. The interface is the zero level of the level set function φ-see equation (4).

Here, the level set function φ is initialized as the signed distance to the interface. The unit normal on the interface can be expressed in terms of φ—see equations (5).

Since embodiment of the present invention consider inks with non-uniform solute concentration (hence non-uniform ink density and dynamic viscosity), equation (6) is solved for the redistribution of the concentration in fluid #1 (ink), where C is the solute concentration. A density-concentration relation and a viscosity concentration relation will close the set of equations—see equations (7).

It shall be noted that since, in embodiments, the solute density is usually higher than the solvent (water), the density-concentration relation and viscosity concentration relation are usually monotonically increasing functions, i.e. see equations (8). It shall also be noted that, for the ink-air system, the ink solute concentration C exists in fluid #1 (ink). Furthermore, in embodiments, we do not include the diffusion term in equation (6). But to include the diffusion term would be easy for one of ordinary skill in the art.

Let u be defined as in equation (9). The governing equations for the two-phase flow and the boundary condition at the interface can be re-written as shown in equations (10) and (11), where δ is the Dirac delta function. It shall be noted that the surface tension may be written as a body force concentrated at the interface.

To make the governing equations dimensionless, the definitions as shown in equations (12) are chosen, where the primed quantities are dimensionless and L, U, ρ₀, μ₀ are respectively the characteristic length, characteristic velocity, density of the solvent of fluid #1, and the highest dynamic viscosity of fluid #1. The solute concentration, in terms of the ratio of solute mass to solution (ink) mass, is already dimensionless.

Substituting the above into equations (10) and (11), and dropping the primes yields equations (13) and (14), where the density ratio, viscosity ratio, Reynolds number, and Weber number are defined by equations (15).

Since the interface moves with the fluid, the evolution of the level set is governed by equation (16). In embodiments, this form is chosen because the interface moves advectively.

Since equations (6), (13), and (14) are expressed in terms of the vector notation, they assume the same form in Cartesian coordinates and axi-symmetric coordinates. In axi-symmetric coordinates (r, z), the curvature can be expanded as shown in equation (17), where the subscripts r and z denote the partial derivatives—e.g., see equations (18).

### 2.2 Equations on Quadrilateral Meshes

In embodiments, we are interested in computing in reasonably complex geometries, in which rectangular grids may not work well. Instead, in embodiments, it is preferred a body-fitted geometry generated by a quadrilateral grid. To build an appropriate finite difference solution on these meshes, the governing equations are first formulated.

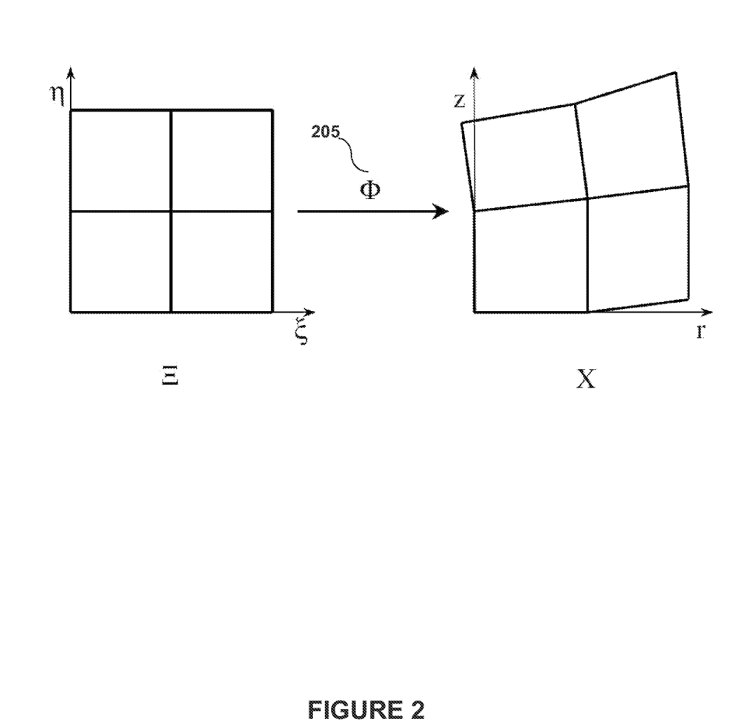

Consider a continuous transformation Φ which maps the grid points in a rectangular computational space Ξ=(ξ, η) to the physical space X=(r, z) according to equation (19) and as shown in FIG. 2. The Jacobian and the transformation matrix (metric) are defined by equations (20), where g=2πr for the axi-symmetric coordinate system. For the convenience of future discussion, we also define the transformed convection velocity as in equation (21).

The above definitions for axi-symmetric coordinate systems can be easily extended to the two-dimensional Cartesian system by the substitution shown in (22).

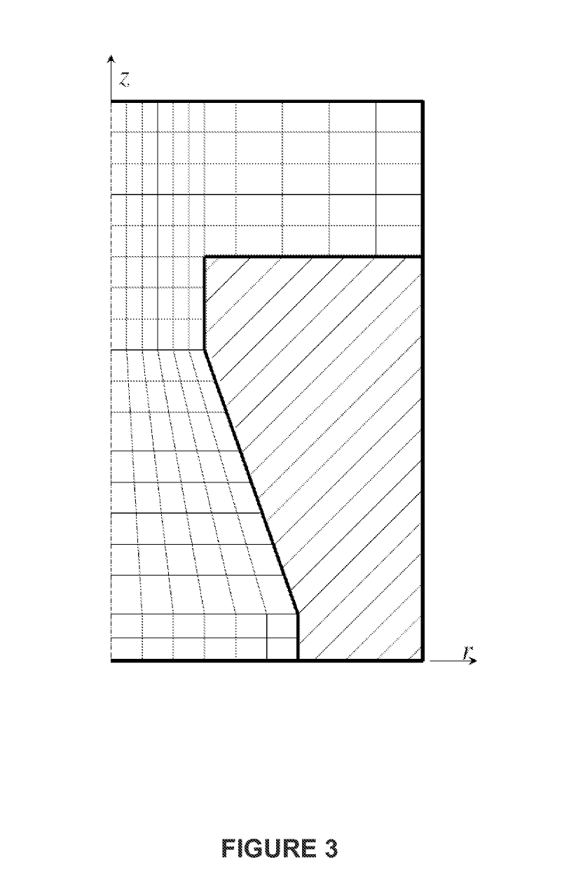

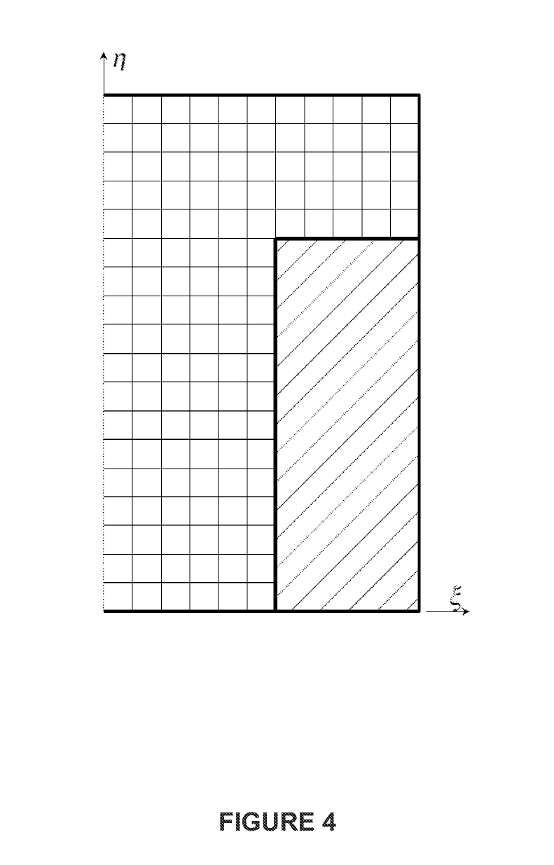

In embodiments of the ink jet simulations, a body-fitted quadrilateral grid in the physical space is shown in FIG. 3. The corresponding uniform square grid system in the computational space is shown in FIG. 4. It should be noted that the grid lines in the physical space are not orthogonal. An almost orthogonal quadrilateral system would facilitate the implementation of boundary conditions and contact models. Nonetheless, the grid in FIG. 3 is easy to generate, and adequately (as presented below) handles the boundary conditions. The algorithms developed below work for any rectangular grid systems in the computation space; for embodiments of ink jet simulations depicted herein, the uniform square grid shown in FIG. 4 in the computational space is used.

In the following subsections, the derivation of the transformed viscosity term and surface tension term in the computational space is shown.

### 2.2.1 Viscosity Term

The complexity of the transformed viscosity term comes from the O-related tensor component of the velocity gradient, which equation (23) shows in the diadic form. The r and z-related tensor components can be transformed by equation (24). The O-related component turns out to not need any sort of special transformation, since equation (25).

By combining equations (23) to (25) and the definition of the rate of deformation tensor, the viscosity term on quadrilateral grids is obtained as shown in equation (26).

### 2.2.2 Curvature and Surface Tension

Given the relationship in equation (27), the transformed surface tension term is easily obtained as equation (28).

Combining equations (26) to (28), we obtain the transformed governing equations (29), where the viscosity term is given in equation (26) and the surface tension term is given in equation (28).

It shall be noted that equations (26) to (29) are derived for a quadrilateral grid in the axi-symmetric coordinate system; however, they can be used for two-dimensional flow problems if the last term in equation (26) is neglected and the substitution in equation (22) is used. Also, equation (26) can be checked by reducing the computational space Ξ=(ξ, η) to the physical space X=(r, z). For this case, the transformation matrix reduces to the identity matrix and the Jacobian to g. Furthermore, it should be noted that ∇_{Ξ} and ∇_{Ξ}• are “matrix operators” while ∇ and ∇• are vector operators. When a vector operator is put in front of a vector quantity, it not only “operates” on the magnitude of the vector quantity but also on the direction. Here, the matrix operators ∇_{Ξ} and ∇_{Ξ}• are applied to scalars or matrices, and hence the “direction” is not relevant. Also, in embodiments, the quadrilateral-grid algorithm is defined in terms of the Jacobian J and metric T. The elements in the metric and the Jacobian are calculated using appropriate grid point locations. However, in embodiments, the algorithm does not explicitly use the continuous mapping Φ. In embodiments, only the grid point locations in the physical space are needed.

### 2.3 Boundary Conditions and Contact Model

On solid walls it is assumed that the normal and tangential components of the velocity vanish, although this assumption must be modified at the triple point. At both inflow and outflow, the formulation allows us to prescribe either the velocity (30) or the pressure (31) boundary conditions, where n denotes the unit normal to the inflow or outflow boundary.

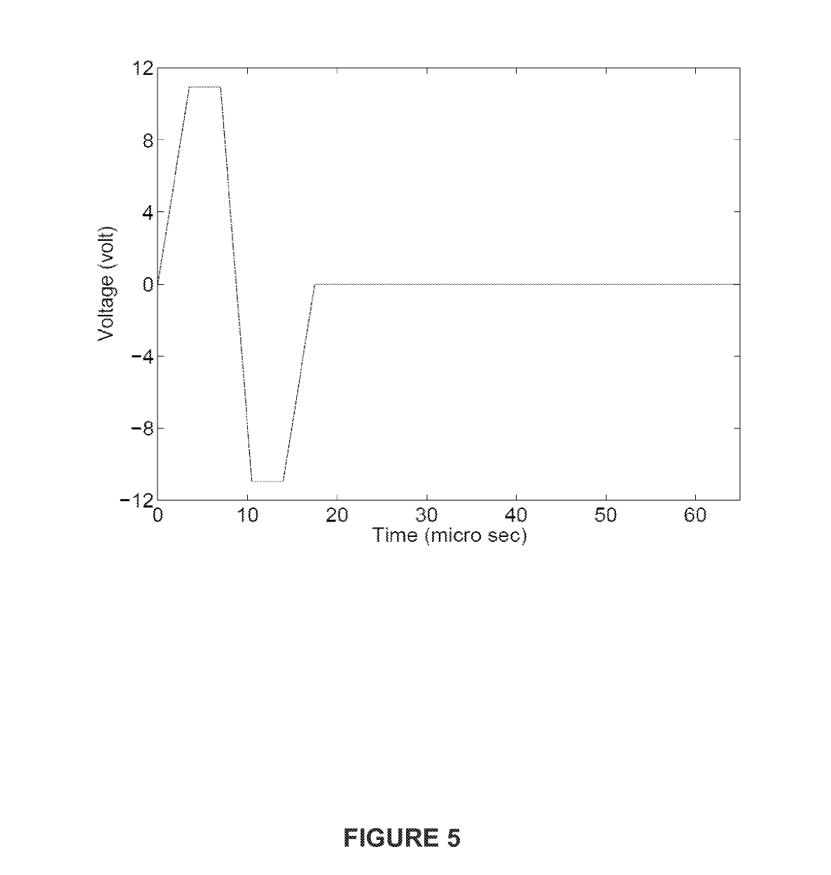

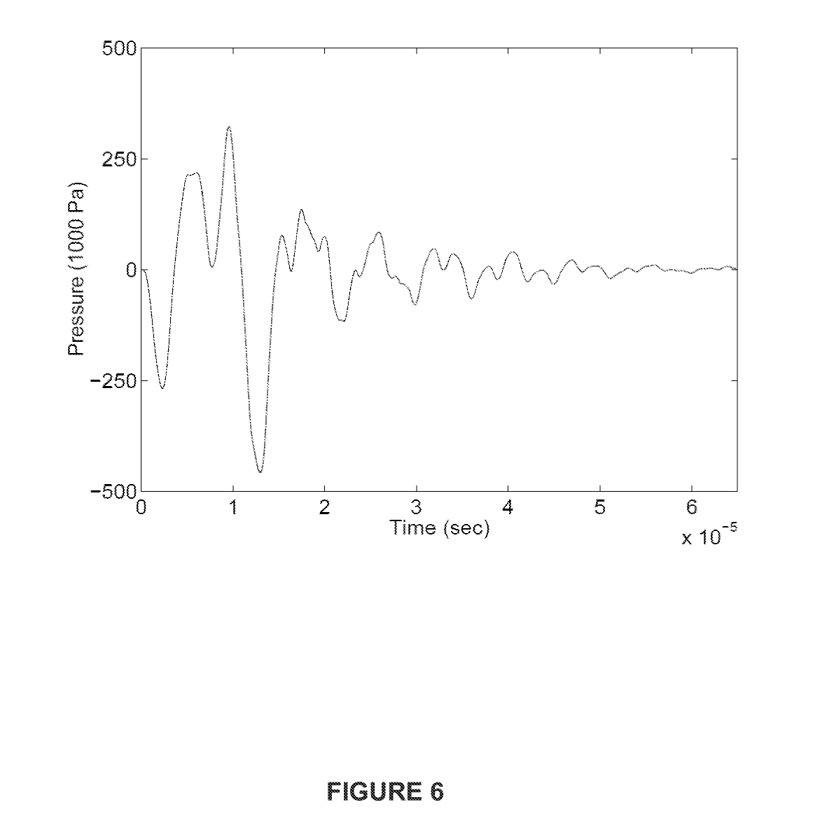

To numerically simulate the ejection of ink droplets, a velocity or pressure at the inflow to the nozzle should be prescribed. However, typically only the input voltage to the piezoelectric actuator is known. In embodiments, an equivalent circuit model is employed to handle the problem. The equivalent circuit, which includes the effect of ink cartridge, supply channel, vibration plate, and piezoelectric actuator, simulates the ink velocity and pressure at nozzle inflow with a given dynamic voltage. By solving the equivalent circuit and the flow equations in turn, one simulates a real ink jet. A typical driving voltage pattern and a typical inflow pressure are as shown in FIGS. 5 and 6, respectively. The driving voltage is such that the ink is first pulled back, pushed and fired, and then pulled back to get ready for the next jetting. The inflow pressure shown in FIG. 6 reflects the reaction of a typical nozzle-ink channel-actuator-cartridge system to the applied voltage. The pressure pattern contains a higher frequency signal. It is basically the fundamental natural frequency of the system, which is five to six times higher than the driving voltage frequency in this case.

In embodiments, at the triple point, where air and ink meet at the solid wall, the slipping contact line model as discussed in U.S. Pat. No. 7,085,695 (application Ser. No. 10/105,138, filed on Mar. 22, 2002) entitled “A Slipping Contact Line Model and the Mass-Conservative Level Set Implementation for Ink-Jet Simulation,” listing Jiun-Der Yu and Shinri Sakai as inventors (which is incorporated herein by reference in its entirety) is used. The contact angle θ is the angle made by the air-liquid interface and the solid, measured from the side of the liquid by approaching the contact line (i.e., the triple point) as close as possible. The advancing critical contact angle θₐ and receding critical contact angle θᵣ are the maximum and minimum contact angles for the triple point to stay. The velocity ν_{B} is the tangential velocity of the point on the interface at 0.5 μm from the triple point. The triple point is allowed to move toward the air side if θ≧θₐ and ν_{B}>0. The triple point is allowed to move toward the liquid side if θ≦θᵣ and ν_{B}<0. If the triple point is not allowed to move, the boundary condition at the solid wall is the no-slip condition. If the triple point is allowed to move, the no-slip condition in a close vicinity of the triple point is switched to the free slip condition. In embodiments, for dye-based ink and print head nozzle wall, θₐ and θᵣ may be about 70° and 20°, respectively.

### 3. Numerical Algorithms

In this patent document, the superscript n (or n+1) denotes the time step (i.e., uⁿ=u(t=tⁿ) and so on). Given quantities uⁿ, p^{n-1/2}, φⁿ, Cⁿ, the purpose is to obtain uⁿ⁺¹, p^{n+1/2}, φⁿ⁺¹, Cⁿ⁺¹ from the governing equations (29). Note that the pressure is retarded in time (by half a time step) in the following coupled second-order level set projection scheme.

### 3.1 Temporal Discretization

In embodiments, the boundary condition on the nozzle wall is given from the contact model, and the inflow pressure p^{n+1/2} is given by the equivalent circuit.

### 3.1.1 Level Set Update

The level set is updated first by equation (32). The methodology for the evaluation of the time-centered advection term [ū·∇_{Ξ}φ]^{n+1/2} is explained in Section 3.2.2. Once φⁿ⁺¹ is obtained, φ^{n+1/2} is computed by equation (33).

### 3.1.2 Solute Concentration Update

The solute concentration is also updated by equation (34).

The methodology for the evaluation of the time-centered advection term [ū·∇_{Ξ}C]^{n+1/2} is explained in Section 3.2.2. Once Cⁿ⁺¹ is obtained, C^{n+1/2} is computed by equation (35).

### 3.1.3 Semi-Implicit Algorithm for Navier-Stokes Equations

In embodiments, the temporal discretization is 2nd-order explicit for the advection term and semi-implicit for the viscosity term. In this scheme, the preliminary velocity u* is first solved from the Navier-Stokes equations using equation (36) where equations (37) and (38) set forth some of the terms used in equation (36). Since the preliminary velocity u* appears at both sides of (36), the viscosity term is inverted to solve for u* in each time step.

In embodiments, we apply a second-order explicit Godunov scheme for the advection term and the central difference for the viscosity term in (36), which will be explained later. It should be noted that the time-centered level set φ^{n+1/2}, which is obtained explicitly, is used for the evaluation of the viscosity term, and hence the viscosity term is not truly semi-implicit.

3.1.4 Projection for uⁿ⁺¹

In order to project the whole velocity and to obtain the whole pressure, the preliminary velocity is replaced by equation (39). Since the finite element (FEM) projection is used, the regular projection equation is used—see equation (40). Taking the divergence and noting that ∇·uⁿ⁺¹=0, we have equation (41). The projection is equation is elliptic. It reduces to a Poisson's equation if the density ratio (ρ(C, φ))^{n+1/2} is a constant. To facilitate code implementation, the finite element formulation presented in equation (42) may be used, where ψ is the weight function, Γ₁ denotes all the boundary with prescribed inflow or outflow velocity u^{BC}. It is easy to verify using the divergence theory that equation (42) implies equation (41) and the boundary condition at Γ₁—see equation (43).

In embodiments, the weight function is chosen to be piecewise bilinear and the velocity u* is taken as constant in each cell. After the pressure p^{n+1/2} is solved from equation (42), the velocity field uⁿ⁺¹ can be obtained by equation (40).

In embodiments of the ink jet simulation, only the inflow pressure and outflow pressure are given. There is no prescribed inflow or outflow velocity. Hence the second term on the right hand side of equation (42) vanishes.

In embodiments, a hybrid multi-grid/IMSL direct solver is employed to resolve the large linear system resulting from the discretization of the finite element projection. In each time step, the multi-grid solver is first used to resolve the linear system. If the multi-grid solver converges (so the L2 norm of the residual is reduced by a factor of 10¹⁰), within fifteen V-cycle, the code will continue for the next time step. If the multi-grid solver cannot converge within fifteen V-cycle, the code will call the IMSL direct solver to resolve the linear system. In the multi-grid solver, the multicolor Gauss-Seidel relaxation or the successive-over-relaxation (SOR) may be used as the smoother at each level except the bottom (coarsest) level, where the conjugate gradient method may be used.

### 3.2 Spatial Discretization

### 3.2.1 The Quadrilateral Grid

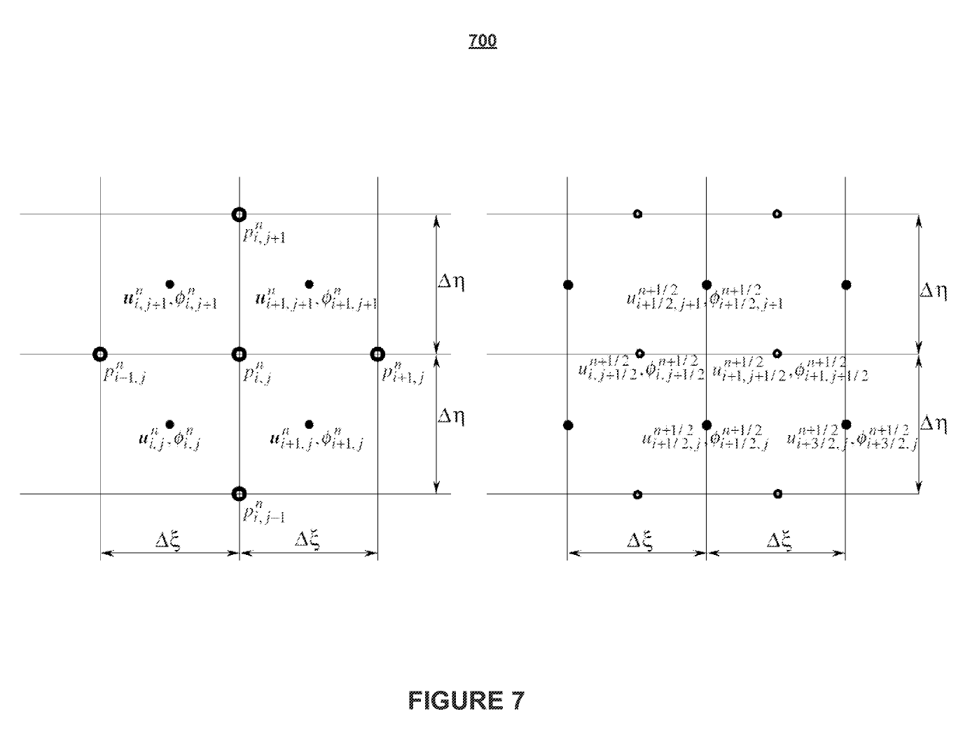

As shown in FIG. 7, the velocity components u_{i,j}ⁿ, the level set φ_{i,j}ⁿ, and the solute concentration C_{i,j}ⁿ are located at cell centers, and the pressure p_{i,j}^{n-1/2} at grid points. The time-centered edge velocities, level set, and solute concentration (i.e., the “predictors”), such as u_{i+1/2,j}^{n+1/2}, φ_{i+1/2,j}^{n+1/2}, and C_{i+1/2,j}^{n+1/2}, are located at the middle point of each edge.

The transformation X=Φ(Ξ) is such that the grid in the computational space is composed of unit squares, i.e., the grid in the computational space has Δξ=Δη=1, and the quadrilateral grid in the physical space is body-fitted. For example, the boundary-fitted quadrilateral grid and the nozzle wall in FIG. 3 are mapped to the uniform computational grid and the rectangular hatched area in FIG. 4. The coordinates of cell centers in the physical space can be calculated as equation (44). Differences of the grid points are used to define the elements of the transformation matrix at cell centers. See, by way of example, equation (45).

### 3.2.2 The Advection Term

In embodiments, the algorithm for the advection terms is based on an unsplit, second-order Godunov-type upwind method. It is a cell-centered predictor-corrector scheme. In the predictor step, we extrapolate the velocities, level set, and solute concentration in space and time to obtain their cell edge values at t^{n+1/2}. In the corrector step, we compute the Godunov upwind fluxes, which are then differenced to obtain an approximation to the advection terms.

### 3.2.2.1 Predictor

In embodiments, for the predictor, a Taylor's series is used to extrapolate the velocity, level set, and solute concentration at tⁿ to obtain their cell edge values at t^{n+1/2}. The partial derivative with respect to time in the extrapolation is substituted by the Navier-Stokes equations, the level set convection equation, or the solute concentration equation. There are two extrapolated values for each velocity components, for level set, and for solute concentration at each cell edge. For example, for the cell edge between cells i, j and i+1, j, extrapolation from the left yields equation (46) where F_{i,j}ⁿ is as given in equation (47). And, extrapolation from the right produces equation (48).

In embodiments, the monotonicity-limited 2nd-order central difference is used for the evaluation of the normal slopes (i.e., u_{ξ,i,j}ⁿ and u_{ξ,i+1,j}ⁿ in this case). The limiting is done on each component of the velocity at tⁿ separately. The transverse derivative terms ( v̅u_{η})_{i,j}ⁿ and ( v̅u_{η})_{i+1,j}ⁿ are evaluated by the simple upwind difference.

### 3.2.2.2 Corrector

Noted that ū_{i+1/2,j}^{n+1/2} u_{i+1/2,j}^{n+1/2}, represents the flux of u^{n+1/2} through cell edge i+1/2 j, using equation (49) in the calculation of the transformed convection velocity ū_{i+1/2,j}^{n+1/2}. Similarly, v̅_{i,j+1/2}^{n+1/2} u_{i,j+1/2}^{n+1/2} is the flux of u^{n+1/2} through cell edge i, j+½, if equation (50) is used. These suggest the finite volume type differencing for the corrector as shown in equations (51), (52), and (53).

In embodiments, before the evaluation of the convection terms can be done, the local Riemann problems are solved to decide the time-centered cell edge velocities and level set from the predictors. The transformed convection velocity is chosen by equation (54) and the upwind velocities and level set by equation (55), where h≡φ or C.

These cell edge convection velocities are, in general, not divergence-free. In embodiments presented herein, an intermediate MAC projection is used to make all the normal advection velocities divergence-free. Suppose q is a function which is smooth enough and u^{e} are the edge velocities obtained as in equations (46)-(55). It is desired that equation (56) be divergence-free. Taking the divergence of (56) yields, in the physical space, equation (57). In the computational space, the above MAC projection equation is transformed as equation (58). The boundary conditions for q are similar to those for the pressure. At the inflow or outflow, if a pressure is given, equation (59) may be used, where Δp^{BC} is the increment of the boundary pressure. If a velocity is prescribed, equation (60) may be used.

It should be noted that, for ink jet simulations in embodiments depicted in this patent document, the inflow pressure calculated by the equivalent circuit is used to drive the coupled level set projection code at each time step. The code solves the governing equations and feeds back the ink flow rate to the equivalent circuit, which then calculates a new inflow pressure for the next time step. Since a pressure instead of a velocity is given at the inflow, the velocity predictors at the inflow and outflow are simply extrapolated from the interior. And, they are not upwinded in the corrector step. This dilemma does not go away if the inflow velocity is prescribed by the equivalent circuit. Since the actuator first pulls the ink back and then pushes to fire a droplet, the inflow velocity is negative at the beginning of each droplet ejection. The upwind direction is at outflow, where no velocity information is available. Further, since geometry scales considered herein are very small, the time step is dominated by the viscosity constraint (see section 3.4). That is, both Δt and Δp are proportional to the square of mesh size. Hence ΔtΔp^{BC} is negligible and can be replaced by a homogeneous boundary condition in the MAC projection.

The discretization of equation (58) can be easily done by a finite volume type differencing. It shall be observed that ū_{i+1/2,j} (or v̅_{i,j+1/2}) is a flux through the edge i+½, j (or i, j+½) if equation (49) (or equation (50)) is used to define the metric at the midpoint of cell edges. Hence equation (58) is discretized as equation (61), given M_{i+1/2,j} as indicated in (62) and with M_{i-1/2,j}, M_{i,j+1/2}, and M_{i,j-1/2} similarly defined. In equation (62), the Jacobian J_{i+1/2,j} and the metric T_{i+1/2,j} are calculated using equation (49). The gradient is by central difference.

After q is solved, the edge advective velocities are replaced as shown in (63).

Evaluation of the normal derivatives.

In embodiments, the normal derivatives in equation (46) and equation (48) are evaluated using the monotonicity-limited central difference. The central, forward, and backward differences are first calculated as shown in equations (64). These values are used to define the limiting slope in equation (65). The second-order limited slope is given in equation (66).

Evaluation of the Tangential Derivatives

In the Taylor's extrapolation (46) and (48), stability requirements suggest that the tangential derivative should be computed using some upwind schemes. In embodiments, one option is given by equation (67).

### 3.2.3 The Viscosity Term

In embodiments, the discretization of the viscosity term (26) is done using standard central differences. For example, at cell i, j on the computational grid, the first part at the right hand side of (26) is discretized as given in equation (68), where [symbol] _{i+1/2,j} is given by equation (69), with [symbol] _{i 1/2,j}, [symbol] _{i,j+1/2}, and [symbol] _{i,j 1/2} similarly defined. In equation (69), the Jacobian, transformation matrix, relative viscosity, and velocity gradient at the cell edge are calculated by averaging or central difference—see equations (70).

### 3.2.4 The Surface Tension Term

In embodiments, the surface tension term is also discretized using standard central differences. For example, the divergence in (28) is discretized as shown in equation (71), where [symbol] _{i+1/2,j} is given by equation (72) with [symbol] _{i-1/2,j}, [symbol] _{i,j+1/2}, and [symbol] _{i,j-1/2} defined similarly. Again, the velocity gradient and metric at the cell edge are calculated by central difference or by averaging.

### 3.3 Interface Thickness and Time Step

In embodiments, because of the numerical difficulty caused by the Dirac delta function and by the sharp change of ρ and μ across the interface, the Heaviside and Dirac delta functions are replaced by smoothed functions, such as shown in equation (73). Accordingly, equation (74) shows the smoothed delta function. It is clear that the thickness of the interface is 2ε if the level set is a distance function. In embodiments of numerical calculation, the parameter ε is chosen to be related to the mesh size as depicted in equation (75), where 1.5≦α≦2. The thickness of the interface reduces as the mesh is refined. Nonetheless, for any numerically practical choices, the interface will have some smearing.

### 3.4 Time Step Constraint

Since, in embodiments presented herein, the time integration scheme is 2nd-order semi-implicit, the time step Δt is constrained by the CFL condition, surface tension, viscosity, and total acceleration—see equation (76), where h=min(Δr,Δz) and F is defined by equation (47).

### 4. Level Set Re-Initialization

The level set is initialized as a signed (shortest) distance function. However, after updating the level set using equation (32) for a few time steps, it will not remain so. To correctly capture the interface and accurately obtain the interface curvature (hence the surface tension term), the level set should be maintained as a signed distance function to the interface. In embodiments, the level set is re-initialized as the signed distance every few time steps. The re-initialization of level set in embodiments presented herein consists of two steps: (1) employing a contour plotting algorithm to find the zero level; and (2) computing the shortest signed distance from each cell center to the zero level. In embodiments, the solute concentration is also re-initialized at those cell centers that are not occupied by fluid #1 (ink).

### 4.1 Contour Plotting Algorithm

Since the nozzle and connection channel geometries considered herein is axi-symmetric, a two-dimensional (2D) contour plotting algorithm will work. Since the level set values are located at cell centers, an imaginary mesh, in which the imaginary grid lines connect the cell centers, is used to implement the 2D contour plotting algorithm. It is noted that, if the mesh for the simulation is m×n, the imaginary mesh for 2D contour plotting algorithm will be (m+1)×(n+1).

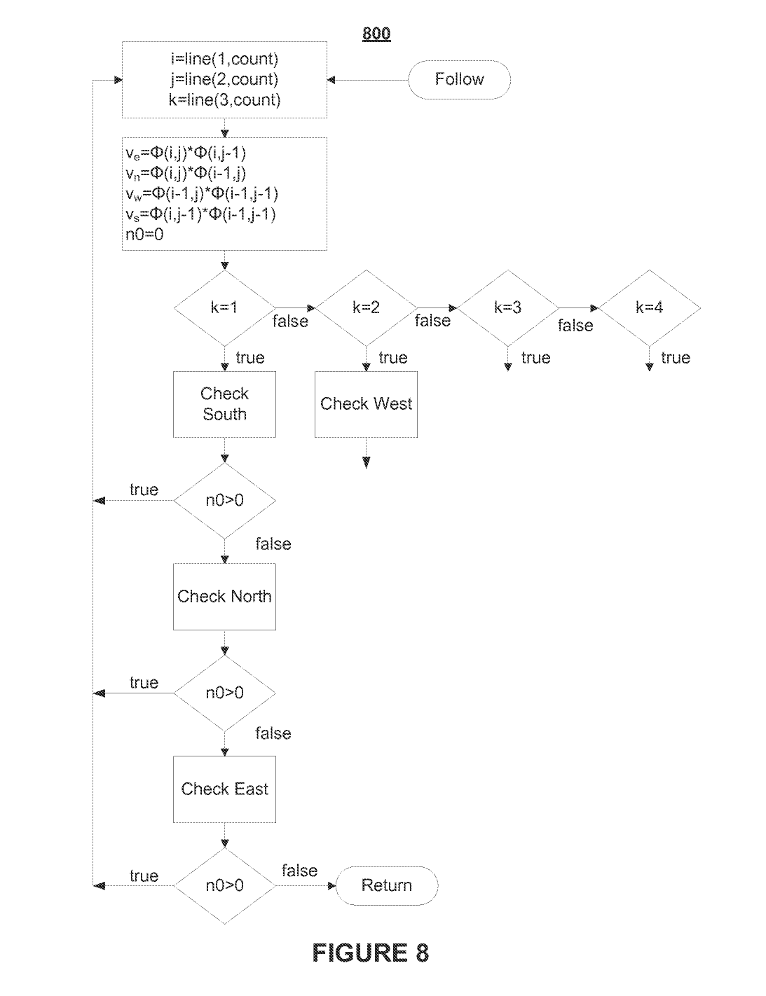

Embodiments presented herein are based on the fact that a zero level (or interface) is either a closed contour or will end on the boundary of the computational domain. The basic idea is to first check an edge of the imaginary mesh. If the current level set values at the two ends of the edge have the same sign, the zero level does not pass through the edge. In embodiments, the edge may be tagged (because it does not need to be checked again) and then look at another edge. If the current level set values at the two ends of the edge have different signs, the zero level passes through the edge. Again, tag the edge so it will not be checked again. But since the zero level passes through the edge, we want to check a neighbor edge and follow the zero level until we return to the first edge or until we reach the boundary of the computational domain. FIG. 8 depicts an algorithm which would follow the zero level. One skilled in the art shall recognize that any of a number of contour plotting methods may be employed.

### 4.2 Calculation of Shortest Distance to the Zero Level

Suppose the zero level line segments have already been found by a certain contour plotting algorithm. In embodiments, the shortest distance from a cell center (r_{i,j}, z_{i,j}) to the zero level is sought (i.e., to the collection of all the line segments).

Suppose the end points of a line segment are denoted by (r₁, z₁) and (r₂, z₂). The parametric form of a straight line passing through (r₁, z₁) and (r₂, z₂) is given by equation (77), where t is the real parameter. If 0≦t≦1, the above form represents the line segment from (r₁, z₁) to (r₂, z₂). The shortest point from the cell center to the line is such that the vector from the shortest point to the cell center is orthogonal to the line as shown in equation (78). Hence, the corresponding parameter t can be determined by equation (79). Since what is desired is the shortest point on the line segment (not the “whole line”), the parameter t is constrained between 0 and 1. That is to say, if t>1, t=1; if t<0, t=0.

After the parameter for the shortest point is determined, the shortest distance from this line segment to the cell center is found by equation (80). Recall that the level set value at a cell center is the signed shorted distance from the cell point to the zero level (i.e., the collection of all the line segments). So, the shortest distances from each cell center to all the line segments are calculated, and the smallest value is kept as the new level set value. The sign of the new level set value at a cell center will be the same as the old level set value at that point before the re-initialization.

### 5. Ghost Region Methods for Solute Concentration

### 5.1 Ghost Region Methods

In embodiments, the initial values of solute concentration of ink (fluid #1) are considered as given. The initial solute concentration distribution is only available and reasonable in fluid #1 (ink). In embodiments in which the second fluid (fluid #2) is air, it is not defined. This gives some freedom to define the concentration values in fluid #2 based on convenience. One embodiment is to just set zeros at all the cell centers located in air and created a smeared interface in which the concentration reduces smoothly from a non-zero value to zero. However, it is often that the concentration is highest at the ink-air interface. The big concentration gradient across the interface together with the numerical viscosity will soon diffuse the concentration deep into the air region. It is not unusual to see that a cell which in the air region and far from the interface has a nonzero concentration only after a few time steps. This can reduce the accuracy of the simulation.

In alternative embodiments, a “ghost region” methodology is employed. With such a method, the concentration is not smeared across the interface. For each cell center that is located in the region of ink, the concentration is the real solute concentration at the cell center location. However, for each cell center that is located in air, the closest point on the interface is found, and then, the concentration at the closest point is used as the concentration at the cell center. In this way, all the cells whose center falls in the region of air are filled with artificial concentration values, which are designed to facilitate the numerical solution of the concentration convection equation. Hence, the method is referred to as a “ghost region” method due to the fact that not just one or two layers of ghost values are generated and used.

The “ghost region” method can be easily extended to more general multi-phase fluid simulations. For example, if one has a two-phase fluid system and needs to track one concentration distribution in each of the two phases (C₁ and C₂), the cell centers in the region of phase #1 will have the real values of the concentration distribution of phase #1 (C₁), while the cells whose centers are located in the region of phase #2 are ghost cells and have the artificial values. The cell centers in the region of phase #2 will have the real values of the concentration distribution of phase #2 (C₂), while the cells whose centers are located in the region of phase #1 are ghost cells and have the artificial values.

It should be noted that the “ghost region” methodology helps insure that the concentration gradient across the interface will be small and, hence, the numerical viscosity is minimal.

### 5.2 Re-Initialization of Concentration

In embodiments, the solute concentration values at cell centers that are occupied by fluid #1 (ink) are not re-initialized. However, in embodiments, those ghost values in fluid #2 (air) are re-initialized whenever the level set is re-initialized because numerical diffusion may smear those values.

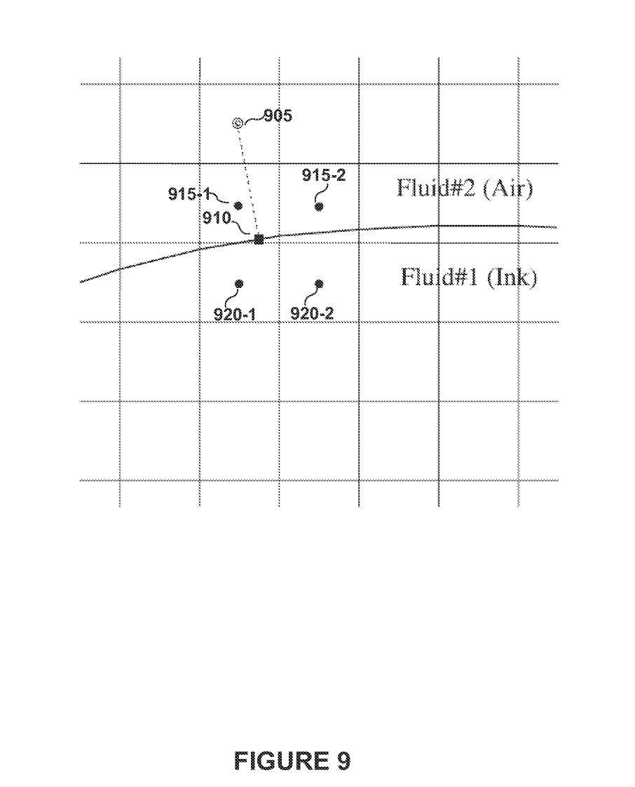

As shown in FIG. 9, consider that it is wanted to re-initialize the solute concentration at the cell center that is marked by a hollow circle 905 and is occupied by air. The shortest point on the zero level to the cell center is marked by a solid square 910. In embodiments, to re-initialize, the solute concentration value at the closest point to the cell center under consideration is copied. However, in the depicted embodiment, the real solute concentration of fluid #1 (ink) is located at cell centers. Accordingly, the value at the closest point needs to be obtained. One skilled in the art shall recognize that a number of methods may be employed to obtain the value. For example, two embodiments include (hut are not limited to): (1) interpolating using the current real 920-x and ghost solute concentration values 915-x from a set of closest cell centers (e.g., four cell centers as marked by solid circles in FIG. 9); or (2) extrapolating using only current real solute concentration values from cell centers in fluid #1 (ink) (e.g., the two cell centers 920-1 and 920-2 marked by solid circles in the fluid #1 region in FIG. 9).

### 5.3 Calculation of Ink Viscosity

The ink dynamic viscosity is related to the solute concentration μ₁=f₁(C). The function relation can be obtained by experiments. Usually, the ink dynamic viscosity is a monotonically increasing function of solute concentration. Since the interface is smoothed, the dimensionless dynamic viscosity may be calculated using equation (81), where H(φ_{i,j}) is the smoothed Heaviside unit step function, μ₁ is the ink dynamic viscosity calculated using the experimentally obtained function relation, μ₂ is the dynamic viscosity of air, and μ₀ is the highest ink dynamic viscosity (used as viscosity scale).

In embodiments, the ink density may be calculated and smoothed in a similar manner.

### 6. General Method Embodiments

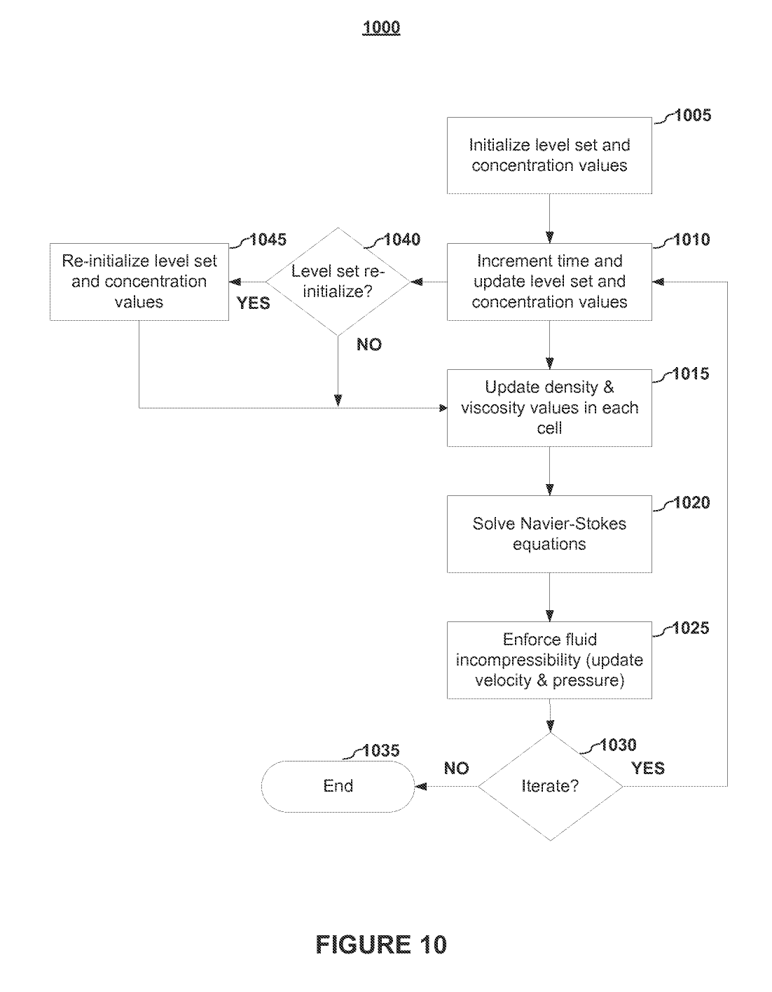

The foregoing sections set forth detailed information regarding embodiments of fluid system simulations using a ghost region. FIG. 10 depicts a generalized method employing a ghost region in simulating a fluid system according to embodiments of the present invention. As depicted in FIG. 10, in embodiments, the general method begins by initializing (1005) the level set and fluid property values at each of the cell center in a mesh. In the depicted example, the property value is concentration values, but one skilled in the art shall recognize that other values or metrics may be used. In embodiments, the time value is incremented and the level set and concentration values are updated (1010). One skilled in the art shall note that in the first iteration, the time may not be incremented. Next, the density and viscosity values in each of the cells are updated (1015) and the Navier-Stokes equations are solved (1020). In embodiments, the fluid incompressibility is enforced (1025) by updating velocity and pressure values.

In embodiments, the process is iterated (1030) until a stop condition is reached and the simulation ends (1035). One skilled in the art shall recognize that a stop condition may be user-selected and may be any of a number of conditions or combinations thereof, including, by way of example and not limitation, the number of iterations, a set time period, an amount of movement, etc.

In embodiments, when the process iterates, it returns to step 1010, in which the time value is incremented and the level set and concentration values are updated. In embodiments, a check may be performed to determine whether to re-initialize (1040) the level set values. The factors to determine whether to re-initialize the level set may be user-selected and may include one or more factors such as, by way of example and not limitation, number of iterations, amount of movement of the interface, etc. If the level set does not meet the condition or conditions for re-initialization, the process continues (1015) as stated above. If, however, the level set does meet the condition or conditions for re-initialization, the level set values and the property values, in this case concentration values, are re-initialized (1045). As discussed with reference to Section 4, above, a contour plotting method, many of which are well known in the art, is employed to define the new interface for the level set values. Following re-initialization, the process returns to step (1015) and the process continues until a stop condition is reached.

### 7. Numerical Examples and Discussions

As a numerical example, consider a typical nozzle as in FIG. 1. The diameter is 25 microns at the opening and 49.5 microns at the bottom. The length of the nozzle opening part, where the diameter is 25 microns, is 25 microns. The slant part is 55 microns and the bottom part is 10 microns.

The inflow pressure is determined by an equivalent circuit, which simulates the ink in the supply channel considering the effect of the ink cartridge, supply channel, vibration plate, and piezoelectric (PZT) actuator for given dynamic voltage. Assumed that the input voltage is given by FIG. 5, where the peak voltages are ±10.96 volts. The corresponding inflow pressure is as shown in FIG. 6. The outflow pressure at the top of the solution domain is set to zero.

The solution domain was chosen to be {(r, z)|0≦r>32 μm, 0≦z≦971 μm}. The critical contact angles are 70° for advancing and 20° for receding. The initial meniscus was assumed to be flat and 2.5 microns under the nozzle opening.

For the purpose of normalization, the nozzle opening diameter (25 microns) was chosen to be the length scale and 6 m/sec to be the velocity scale. The normalized solution domain is hence {(r, z)|0≦r≦1.28, 0≦z≦38.84}.

The initial solute concentration was assumed to be 17% at nozzle opening, 15% at the bottom (nozzle inflow), and decreases exponentially from the nozzle opening to the nozzle inflow. The ink dynamic viscosity vs. solute concentration relation was assumed to be polynomial such that it was 12.46 mPa·sec at nozzle opening and 9.1 mPa·sec at nozzle inflow and in other part of the print head. The ink density and surface tension were assumed to be constant values as given in equations (82). The density and viscosity of air used in the study were as shown in equations (83).

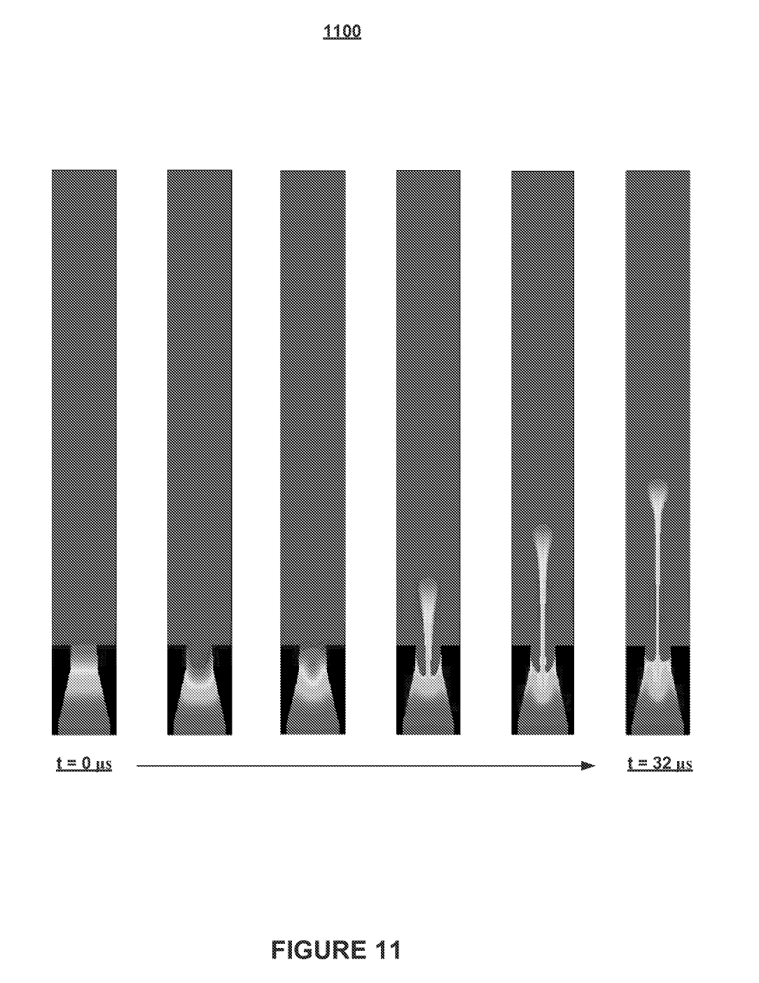

Simulation results from t=0 μs to t=32 μs, using a 32×864 quadrilateral mesh, are plotted in FIG. 11.

### 8. System Embodiments

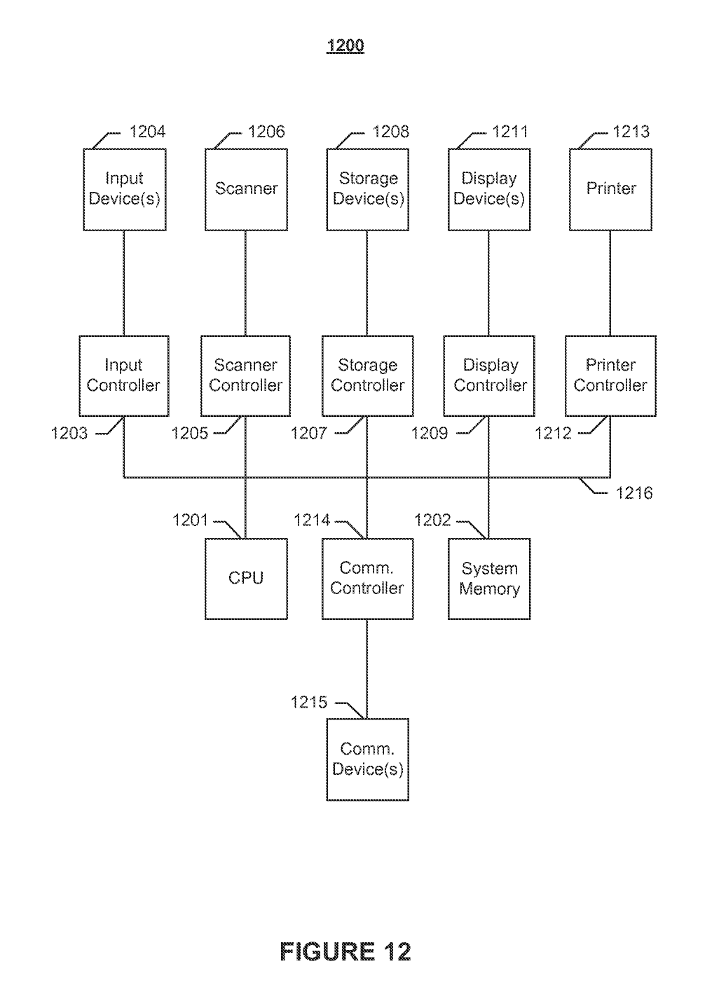

Having described the details of the invention, an exemplary system 1200, which may be used to implement one or more aspects of the present invention, will now be described with reference to FIG. 12. As illustrated in FIG. 12, the system includes a central processing unit (CPU) 1201 that provides computing resources and controls the computer. The CPU 1201 may be implemented with a microprocessor or the like, and may also include a graphics processor and/or a floating point coprocessor for mathematical computations. The system 1200 may also include system memory 1202, which may be in the form of random-access memory (RAM) and read-only memory (ROM).

A number of controllers and peripheral devices may also be provided, as shown in FIG. 12. An input controller 1203 represents an interface to various input device(s) 1204, such as a keyboard, mouse, or stylus. There may also be a scanner controller 1205, which communicates with a scanner 1206. The system 1200 may also include a storage controller 1207 for interfacing with one or more storage devices 1208 each of which includes a storage medium such as magnetic tape or disk, or an optical medium that might be used to record programs of instructions for operating systems, utilities and applications which may include embodiments of programs that implement various aspects of the present invention. Storage device(s) 1208 may also be used to store processed data or data to be processed in accordance with the invention. The system 1200 may also include a display controller 1209 for providing an interface to a display device 1211, which may be a cathode ray tube (CRT), or a thin film transistor (TFT) display. The system 1200 may also include a printer controller 1212 for communicating with a printer 1213. A communications controller 1214 may interface with one or more communication devices 1215 which enables the system 1200 to connect to remote devices through any of a variety of networks including the Internet, a local area network (LAN), a wide area network (WAN), or through any suitable electromagnetic carrier signals including infrared signals.

In the illustrated system, all major system components may connect to a bus 1216, which may represent more than one physical bus. However, various system components may or may not be in physical proximity to one another. For example, input data and/or output data may be remotely transmitted from one physical location to another. In addition, programs that implement various aspects of this invention may be accessed from a remote location (e.g., a server) over a network. Such data and/or programs may be conveyed through any of a variety of machine-readable medium including magnetic tape or disk or optical disc, or a transmitter, receiver pair.

The present invention may be conveniently implemented with software. However, alternative implementations are certainly possible, including a hardware implementation or a software/hardware implementation. Any hardware-implemented functions may be realized using ASIC(s), digital signal processing circuitry, or the like. With these implementation alternatives in mind, it is to be understood that the figures and accompanying description provide the functional information one skilled in the art would require to write program code (i.e., software) or to fabricate circuits (i.e., hardware) to perform the processing required.

In accordance with further aspects of the invention, any of the above-described methods or steps thereof may be embodied in a program of instructions (e.g., software), which may be stored on, or conveyed to, a computer or other processor-controlled device for execution on a computer-readable medium. Alternatively, any of the methods or steps thereof may be implemented using functionally equivalent hardware (e.g., application specific integrated circuit (ASIC), digital signal processing circuitry, etc.) or a combination of software and hardware. In embodiments, one or more of the methods may be implemented using one or more processing units/systems.

While the invention has been described in conjunction with several specific embodiments, it is evident to those skilled in the art that many further alternatives, modifications, and variations will be apparent in light of the foregoing description. Thus, the invention described herein is intended to embrace all such alternatives, modifications, applications and variations as may fall within the spirit and scope of the appended claims.

What is claimed is:

1. A computer-implemented method for simulating fluid flow in a solution domain comprising a first fluid in a first subdomain, a second fluid in a second subdomain, and an interface between the first fluid and the second fluid, the method comprising the steps of:
determining values in the first subdomain of a property of the first fluid, the property being unique to the first fluid;
assigning ghost values of the property in the second subdomain, wherein the first subdomain and the second subdomain form the solution domain; and
using at least some of the values in the first and the second subdomains for finite difference analysis of the property of the first fluid.

2. The method of claim 1 wherein the step of assigning ghost values for the property in the second subdomain comprises:
using at least some of the values of the property of the first fluid in the first subdomain to generate ghost values of the property in the second subdomain.

3. The method of claim 2 wherein each of the first and second subdomains are divided into a plurality of cells and wherein the step of using at least some of the values of the property of the first fluid in the first subdomain to generate ghost values of the property in the second subdomain comprises:
for each cell in a set of cells in the second subdomain:
identifying a point on the interface;
obtaining a value of the property for the identified point on the interface; and
using the value to generate a ghost value of the property for the cell in the second subdomain.

4. The method of claim 3 wherein the step of obtaining a value of the property for the identified point on the interface comprises:
obtaining the value of the property at each of K nearest neighboring cells; and
using the values of the property at the K nearest neighboring cells to interpolate the value for the identified point on the interface.

5. The method of claim 3 wherein the step of obtaining a value of the property associated with the identified point on the interface comprises:
obtaining the value of the property at each of K nearest neighboring cells in the first subdomain; and
using the values of the property at the K nearest neighboring cells in the first subdomain to extrapolate the value for the identified point on the interface.

6. The method of claim 1 wherein the first fluid is ink, the second fluid is air, and the property is solute concentration.

7. The method of claim 1 wherein the step of using at least some of the values in the first and the second subdomains for finite difference analysis of the property of the first fluid comprises:
(a) performing finite difference analysis, with reference to both a quadrilateral grid in a physical space and a uniform square grid in a computational space, equations governing two-phase fluid flow including a level set convection equation having a level set function for the flow of the first and second fluids through at least the portion of a channel, the level set function taking into consideration an effect of the interface as it moves through at least the portion of the channel, wherein the equations are first derived for the quadrilateral grid in the physical space and then transformed to the computational space for application on the uniform square grid on which the equations are solved; and
(b) simulating the flow of the first fluid through at least the portion of the channel based on the performed finite difference analysis.

8. The method of claim 7, wherein the first fluid is ink, the second fluid is air, and the channel comprises an ink-jet nozzle that is part of a piezoelectric ink jet head.

9. A non-transitory computer-readable medium comprising one or more sequences of instructions which, when executed by one or more processors, causes the one or more processors to perform the method of claim 1.

10. A computer-implemented method for simulating fluid flow in a domain segmented into a plurality of cells and the domain comprising a first region occupied by a first fluid, a second region occupied by a second fluid, and an interface between the first and second fluids, the method comprising the steps of:
obtaining level set values of the interface for each cell from the plurality of cells of the domain;
obtaining values of a property of the first fluid in the first region occupied by the first fluid, the property being unique to the first fluid;
generating artificial values of the property in the second region occupied by the second fluid; and
updating the level set values and the values of the first fluid in the first region during an iteration.

11. The method of claim 10 further comprising:
(a) deriving partial differential equations applicable to a quadrilateral grid in a physical space, including deriving a viscosity term, a surface tension term, and a level set convection equation for two-phase flows;
(b) calculating a transformation for transforming the derived partial differential equations for application to a uniform square grid in a computational space; and
(c) solving the derived and transformed partial differential equations to determine the flow of the first fluid through, and ejection from, the channel.

12. The method of claim 11, wherein in step (c) the derivatives of velocity, pressure, and level set for the flow of the first fluid in the derived and transformed partial differential equations are calculated with reference to the uniform square grid in the computational space.

13. The method of claim 11, wherein the first fluid is ink, the second fluid is air, and the channel comprises an ink-jet nozzle that is part of a piezoelectric ink jet head.

14. A non-transitory computer-readable medium comprising one or more sequences of instructions which, when executed by one or more processors, causes the one or more processors to perform the method of claim 10.

15. A non-transitory computer-readable medium comprising one or more sets of instructions which, when executed by one or more processors, causes the one or more processors to perform a method for simulating fluid flow, the one or more sets of instructions comprising:
[a] defining a domain comprising a first fluid occupying a first region, a second fluid occupying a second region, and an interface between the first fluid and the second fluid, the domain being divided into a plurality of cells;
[b] initializing a level set value for each of the plurality of cells in the domain and initializing a value of a property unique to the first fluid for each of the plurality of cells in the domain, the values of the property assigned to cells from the plurality of cells in the second region being artificial values;
[c] responsive to incrementing a time value, updating the level set value for each of the plurality of cells in the domain and the value of the property unique to the first fluid for each of the plurality of cells in the domain;
[d] updating density and velocity values in each cell in the domain;
[e] solving a set of Navier-Stokes equations; and
[f] enforcing incompressibility of at least one of the first and second fluids.

16. The non-transitory computer-readable medium of claim 15 further comprising:
responsive to a stop condition not being satisfied, iterating by returning to step [c].

17. The non-transitory computer-readable medium of claim 16 further comprising:
responsive to one or more of the level set values meeting a condition to be re-initialized, re-initializing a level set value for each of the plurality of cells in the domain and re-initializing a value of the property unique to the first fluid for each of the plurality of cells in the region of the second fluid, the values of the property assigned to cells from the plurality of cells in the second region being artificial values.

18. The non-transitory computer-readable medium of claim 17 wherein the operation of re-initializing a value of the property unique to the first fluid for each of the plurality of cells in the second domain is based on at least some of the values of the property of the first fluid in the first region.

19. The non-transitory computer-readable medium of claim 18 wherein to generate artificial values of the property in the second region comprises:
for each cell in a set of cells in the second region:
identifying a point on the interface;
obtaining a value of the property for the identified point on the interface; and
using the value to generate an artificial value of the property for the cell in the second region.

20. The non-transitory computer-readable medium of claim 19 wherein the operation of obtaining a value of the property for the identified point on the interface comprises:
obtaining the value of the property at each of K nearest neighboring cells; and
using the values of the property at the K nearest neighboring cells to interpolate the value for the identified point on the interface.
